(19) United States
(12) Patent Application Publication
(10) Pub. No.: US 2026/0367946 A1
(43) Pub. Date: Nov. 19, 2026

(54) Contextual Video Interface for Enhanced User Engagement

(71) Applicant: Painted Dog, Inc., New York, NY (US)

(72) Inventors: Ken Aizawa, Brooklyn, NY (US); Jared Max Browarnik, Brooklyn, NY (US); Brandon Halim, Brooklyn, NY (US)

(73) Assignee: Painted Dog, Inc., New York, NY (US)

(21) Appl. No.: 19/487,753

(22) PCT Filed: May 24, 2024
(86) PCT No.: PCT/US2024/030977

§ 371 Date: Nov. 25, 2025

Related U.S. Application Data
(60) Provisional application No. 63/504,321, filed on May 25, 2023.

(51) Int. Cl. G06F 9/451

(52) U.S. Cl. CPC G06F 9/452

(57) ABSTRACT

The present technology relates generally to the field of user interfaces for interactive television and multimedia systems, and more specifically to a video interface for user engagement with content across various applications in a manner that is contextually dependent on and relevant to the content displayed on internet-connected TVs, set-top boxes, OTT (“over-the-top) Apps, gaming consoles, streaming devices, AR/MR/VR headsets, tablets, and mobile phones. The invention provides a widget interface in the form of a video overlay, squeeze back, or second—screen user interface on internet-connected TVs, set-top boxes, OTT Apps, gaming consoles, streaming devices, AR/MR/VR headsets, mobile phones, and tablets which allows for user engagement with content across a number of applications embedded in the interface, in a manner that is contextually dependent on and relevant to the content that is displayed on the device—in the case of a second-screen user interface, then the content playing on primary device.

### CROSS-REFERENCE TO RELATED APPLICATION(S)

This application claims a priority benefit, under 35 U.S.C. 119(e), of U.S. Application No. 63/504,321, filed on May 25, 2023, and entitled “Contextual Video Interface for Enhanced User Engagement.” This application is incorporated herein by reference in its entirety.

### FIELD OF INVENTION

The present technology relates generally to the field of user interfaces for interactive television and multimedia systems, and more specifically to a video interface for user engagement with content across various applications in a manner that is contextually dependent on and relevant to the content displayed on internet-connected TVs, set-top boxes, over-the-top (OTT) Apps, gaming consoles, streaming devices, augmented reality/mixed reality/virtual reality (AR/MR/VR) headsets, tablets, and mobile phones.

### BACKGROUND

In the modern era, viewers are increasingly seeking ways to interact with content in a more engaging, personalized, and contextually relevant manner. Traditional television experiences often lack interactivity and personalization, in particular across devices and applications, including but not limited to streaming applications and other web-based and native applications of a device. This can result in viewers feeling disconnected from the content they consume.

### SUMMARY

The present technology addresses this problem by providing a contextual video interface that enhances user engagement through various applications tailored to the content being displayed and the individual preferences of the viewer. The present technology includes system architectures for enabling users to access a range of content related to a current context of the media data, with some of the content made available via applications which may be executing on the media device.

Embodiments of the present technology include a method and system for providing a widget interface in the form of a video overlay, squeeze back, or second-screen user interface on an internet-connected television, set-top box, OTT App, gaming console, streaming device, AR/MR/VR headset, smart phone, or tablet. This allows for user engagement with content across a number of applications embedded in the interface, in a manner that depends on and is relevant to the content that is displayed on the device, through a widget interface.

The widget interface can appear either on the device displaying the content, also called a primary screen device or primary viewing device (e.g., a television), or on a second-screen device (e.g., a smart phone linked to the television). In some cases, the second-screen device is wirelessly linked with the primary screen device. In other cases, the second-screen device is physically attached to the primary screen device. The widget interface between the primary and second-screen devices may communicate via a push-based (e.g., Websocket) and/or pull-based (e.g., HTTP) system.

Web-based or native device applications populate the widget interface based on the video content and, optionally, information about the viewer, such as the viewer's preference. This contextual dependence can be achieved by identifying the video content based on metadata associated with the content, including for example, a timestamp or frame data associated with the video content displayed on the primary screen device. Alternatively, the present technology can determine the context of the video content without identifying the video content. For instance, a machine learning model running on the device can identify actors from the video frames and show information about the actors without necessarily identifying the video itself. The present technology can also use context about the user, either in addition to or instead of context about the video, to determine which widget(s) to show. For instance, if the viewer is 30-year-old male in Los Angeles watching television during a Lakers game, then the device may show a widget with up-to-date sports statistics for that game without necessarily knowing that the viewer is watching that game.

In some aspects, the techniques described herein relate to a method for identifying contextual data for a widget, the method including receiving, at a first server, a representation of at least one of a frame image or a timestamp of video content displayed to a user via a client device, determining, based on the representation of the at least one of the frame image or the timestamp using the first server, a third-party widget, based at least in part on the video content, receiving, by the first server from a second server associated with the third-party widget, information for a widget interface for the third-party widget, determining, by the first server, widget data based on the information and providing, by the first server, the widget data to the widget for display to the user via the widget interface. The information can include a manifest file which includes at least one condition associated with the widget interface; contextual data including at least the third-party widget associated with the frame image or the timestamp of video content and at least one parameter associated with revalidation of at least the third-party widget; or at least one of a snippet of code, executable file or container image used to determine contextual relevance of at least the third-party widget.

Additionally, the techniques described herein relate to a method, further including storing, the information in cache memory in the first server and loading the widget interface with at least the third-party widget by populating a container with a URL, the URL pointing to the second server. In some aspects, the techniques described herein include initiating a transaction in the widget interface, accessing, based on the transaction, a payment platform, wherein the payment platform is accessed by the first server and the second server and completing the transaction, based on a response from the payment platform and the contextual data. The first server can determine in some aspects, based at least in part on at least one contextual parameter, that the widget data is contextually relevant to the video content.

In some aspects, the first server can provide the widget data to the widget for display by accessing the widget data from cache memory in the first server. The widget data is accessed from the cache memory in the first server in response to a request from a subsequent frame image or timestamp of the video content.

Additionally, in some aspects, the first server manages a set of personal profiles, the set of personal profiles including a first profile containing metadata associated with the user including at least one of viewership data, widget engagement data, user preference data, advertisement data, and previously viewed data and a second profile containing a list of applications associated with the widget interface the first profile and the second profile received by the second server and used in determining the information for the widget interface for the third-party widget.

In some aspects, the third-party widget can include at least one of a product widget, a social media widget or a weather widget, with the product widget displaying products associated with content displayed on the client device, the social media widget allowing the user to interact with posts of at least one social media feed, and the weather widget providing weather information.

In some aspects, the techniques described herein relate to a method, further including revalidating the third-party widget based on user identification, user location, and programming identification associated with the video content.

The information for the widget interface is mapped to a user identification or programming identification associated with the video content and storing the information in cache memory on the first server. The widget can be web-based and loaded into the widget interface via an inline frame, where the inline frame is an iFrame component. The iFrame component is loaded with executable code based on the widget information.

In some aspects, the techniques described herein relate to a method, further including generating the third-party widget based at least in part on a list of components and metadata provided by the second server, wherein the information can additionally include the list of components and the metadata as well.

In some aspects, the techniques described herein relate to a method for identifying contextual data, the method including: receiving, at a first server, widget data for a widget interface from a second server or a content database; caching the widget data at the first server; validating the widget data for each of a plurality of users and for each of a plurality of types of video content; receiving, by the first server, an indication that a first user in the plurality of users is viewing a first type of video content in the plurality of types of video content; attempting to re-validate, by the first server, the widget data for the first user and the first type of video content; in response to successfully re-validating the widget data, providing the widget data to the first user via a widget interface; and in response to failure to re-validate the widget data, retrieving, by the first server, new widget data and providing the new widget data to the first user via the widget interface.

In some aspects, the techniques described herein relate to a method, wherein attempting to re-validate the widget data includes checking a parameter specified by the second server or the content database.

In some aspects, the techniques described herein relate to a method, wherein providing the widget data to the first user includes: accessing cached widget data at the first server.

In some aspects, the techniques described herein relate to a method, wherein attempting to re-validate the widget data includes: accessing, from the second server, a list of parameters which are associated with the widget data.

In some aspects, the techniques described herein relate to a method for accessing content in a client device including displaying, by the client device, video content to a user, receiving, by the client device, a command relating to the video content from the user, determining, using a large language model, an intent associated with the command, generating a vector representation based on the intent, determining, based at least in part on the vector representation, a widget interface function associated with the video content and triggering a display of a widget interface implementing the widget interface function with contextual data associated with the video content, the contextual data determined by a server using a set of predetermined parameters stored on a metadata database. The client device can include at least one of a television, a set-top box, a computer, or a mobile device. Additionally, triggering the display of the widget interface causes a second viewing device to display the widget interface, can cause the client device to overlay the widget interface on top of the video content or can display the widget interface as a squeeze back user interface.

The vector representation can be associated with a plurality of commands corresponding to the intent, and a plurality of additional vector representations are mapped to the plurality of commands and the intent. Additionally, determining the intent can further include mapping at least one cluster of vector representations to the intent. The cluster of vector representations are mapped with the user interface data mapped to the at least one cluster of vector representations associated with the intent.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a primary viewing device showing a squeeze back interface according to an embodiment of the invention.

FIG. 2 illustrates a mobile device that is linked to a television and that shows a widget interface associated with video content shown on the television.

FIGS. 3A, 3B, and 3C illustrate different examples of selecting third-party widgets.

FIGS. 4A and 4B illustrate using a software development kit (SDK) to power payments or gamified elements in widget applications.

FIG. 5 illustrates an example of an user interface configured in accordance with embodiments of the present invention.

### DETAILED DESCRIPTION

The present technology provides a widget interface for accessing and navigating to media content, services, and other applications that are related to video content shown on a television or other client device. The widget interface may be embodied in a television application that provides navigation, information, and communication services together, over a full-screen television or embedded/scaled television programming. For instance, the widget interface may cover a region of the primary viewing device either on the sides, or on the top or bottom, leaving the center of the screen unobstructed, or it may occupy the middle of the screen in situations where the interface appears when the content is paused. The widget interface may also be a squeeze back interface, reducing the size of the primary user interface showing the video content on the primary screen device.

The widget interface can also be displayed on a second-screen device, such as a smartphone or tablet linked to the primary viewing device (e.g., a television or other client device). A primary user interface on the primary viewing device provides an indication to the user (e.g., display of a small icon or QR code) which conveys that a widget interface experience is available. The user links the second-screen device to the primary viewing device using the icon or QR code. In response to being linked to the primary screen device, the second-screen device launches a widget interface, which can occupy the entire viewing area (display) of the second-screed device and/or appear with the playing content on the primary viewing device.

The second user interface can include a widget interface which loads a list of relevant widgets as tiles, with each tile briefly summarizing the functionality associated with the tile and any additional information, at a glance. Example widgets may include but are not limited to, product widgets, social media widgets and a weather widget. The product widget, for example, can display the most popular products in a current scene of the video viewed by the user. When the tiles of the widget interface are selected, they expand (potentially covering the entire widget interface), displaying additional functionality. For example, the product widget allows browsing of other products in the scene, including those that are not necessarily popular. The social media widget can for example, display the most popular posts within a range of time, allow for posting and or interacting with certain posts on a social media feed. The weather widget, for example, may display the local temperature of a particular location and/or a current location (i.e. location of the viewing device). The widget interface may be opened directly by the user via a variety of control mechanisms including but not limited to a touch or click on a physical input device such as a conventional TV or game console remote; the second-screen device; foot pedal switch, sip-and-puff switch, or other adaptive/assistive physical apparatus built to facilitate interaction with electronic devices; or alternative input mechanisms such as voice control, sign and gesture control, or eye-tracking control.

### Primary Screen Widget Interface

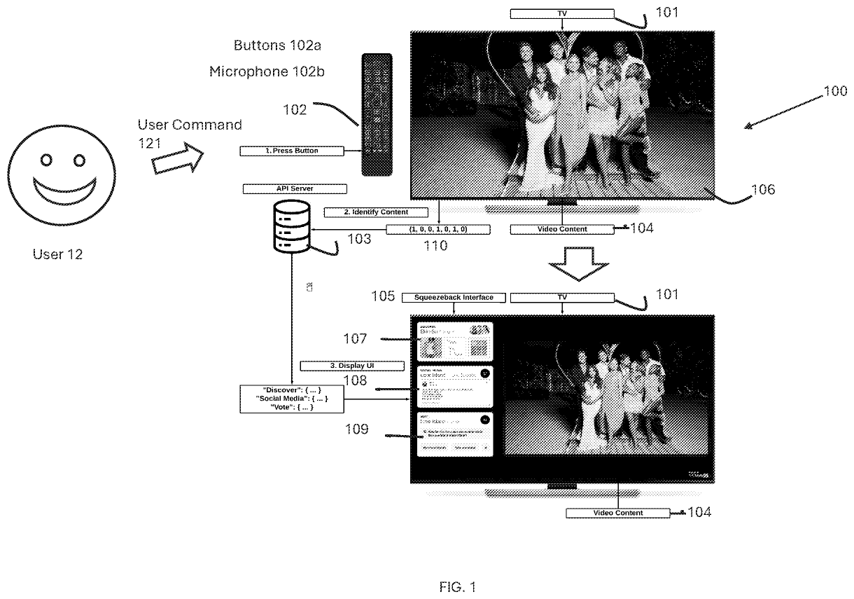

FIG. 1 shows a system 100 with a client device-here, a television 101-that can show video content 104 by itself (top) and show both video content 104 and a widget interface 105 (bottom). The television 101 can be a smart TV or a television with a separate set-top box. Other suitable client devices include computers, tablets, or smart phones. The video content 104 shown on the television 101 can be provided by a content partner (e.g., the Hallmark Channel may provide the source video 104), a distribution partner, or media data downloaded from the internet (e.g., YouTube) or captured from a live video feed (e.g., a live capture of the feed of an NBA game).

In operation, the television 101 receives user commands 121 and other input from a user 12 via buttons 102a and a microphone 102b on a remote control 102. This input prompts an application programming interface (API) server 103 communicatively coupled to the television 101 via a network, such as the internet or a cable network, to identify the video content 104 and/or the user 12 based on contextual information 110 from the television 101. This contextual information 110 can be in the form of a perceptual hash binary (e.g., (1, 0, 0, 1, 0, 1, 0) as shown in FIG. 1) of the image displayed on screen. Sending the perceptual hash binary or similar representation of the image can consume less bandwidth than sending the image itself.

The API server 103 uses this contextual information 110 to identify and provide content, etc., for the widget interface 105 to the television 101, which displays the widget interface 105 as a squeeze back interface. If the contextual information 110 is perceptual hash binary, the API server 103 can compare it to similar binaries for perceptual hashes that are stored in a database and associated with relevant widget metadata that the API server 103 sends to the widget interface 105. For example, the API server 103 can call contextually relevant applications and data in response to a query, temporal positions, and locations associated with the video content 104. The API server 103 identifies the query data, temporal position, and other location data to determine contextually relevant data for populating the squeeze back interface (widget interface) 105. This squeeze back interface can include one or more widgets, including but not limited to, a product widget 107, a social media widget 108, and a poll widget 109.

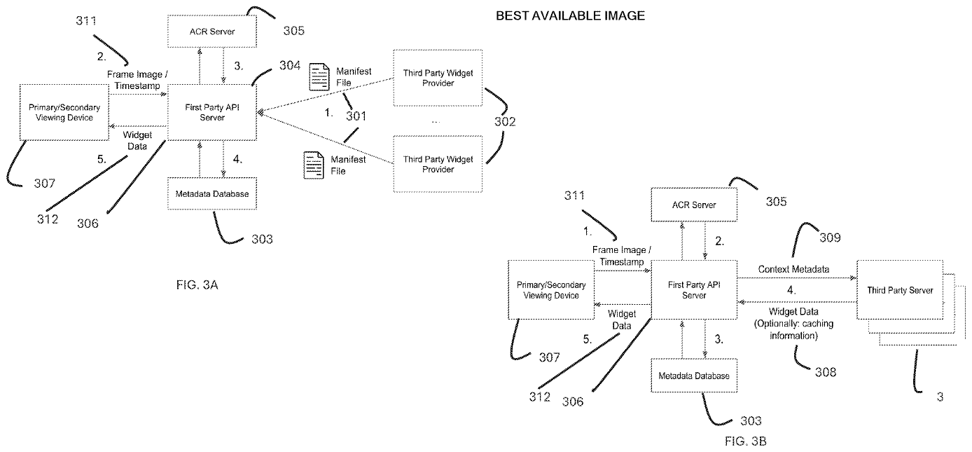

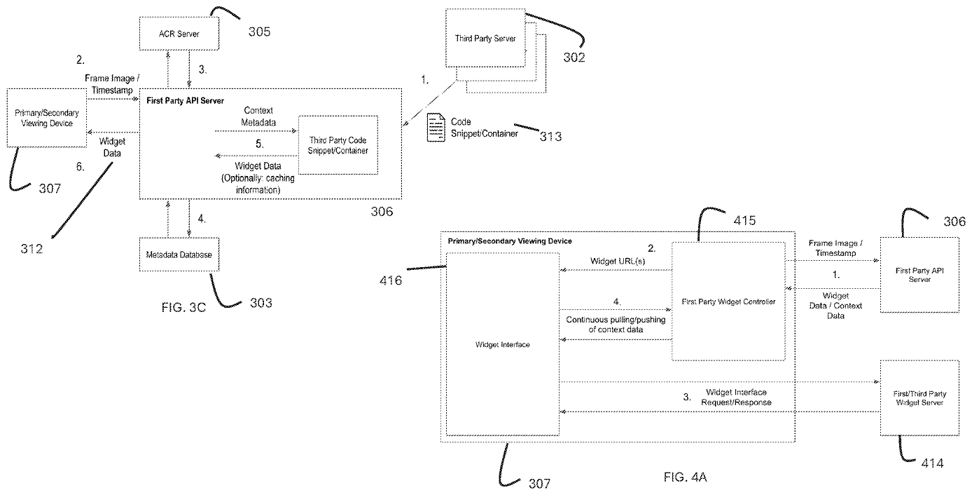

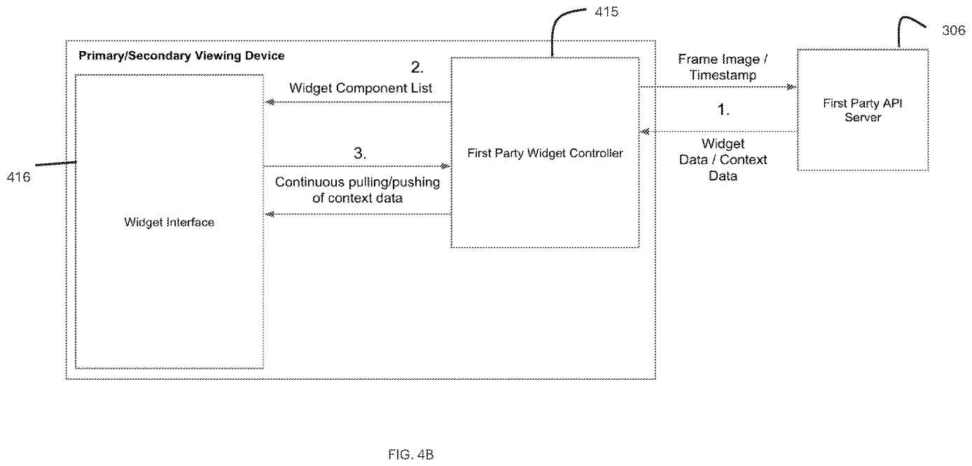

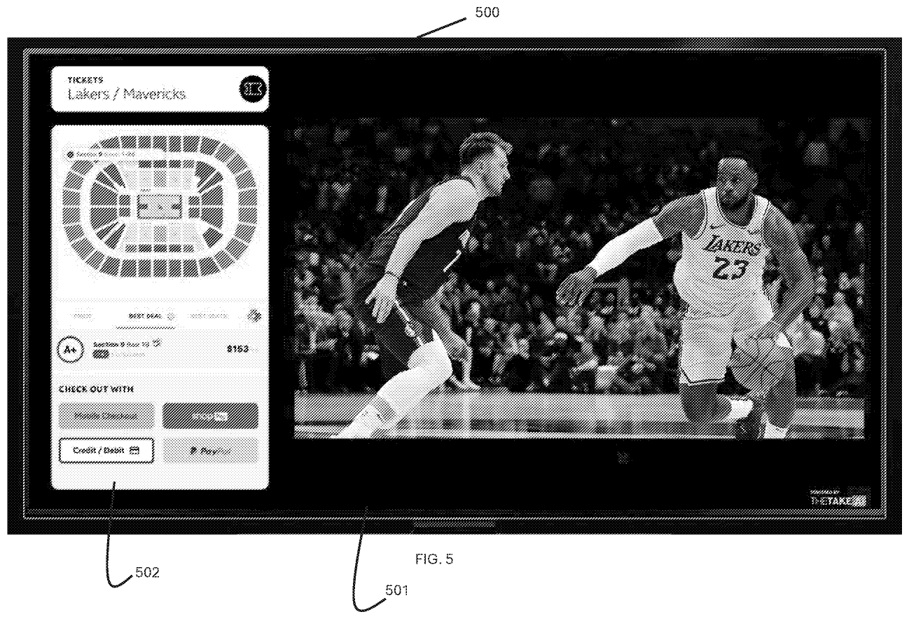

The API server 103 and television 101 communicate over a network, such as the internet or a cable network. The API server 103 can be implemented using software running on appropriate hardware (e.g., a processor, memory, and communications interfaces). The API server 103 provides contextually related data and further may access data from a plurality of servers. The API server 103 may communicate with other servers and/or databases, including one or more third-party servers, databases, data stores, and storage devices as explained below with respect to FIGS. 3A-3C, 4A, and 4B. In some embodiments, there are a plurality of third-party providers, some associated with separate entities. In one scenario, one third-party provider is associated with a streaming application, while a second third-party provider is associated with an e-commerce site and a third third-party provider is associated with an application providing a consumer service.

Although the input mechanism of FIG. 1 is the remote control 102, other suitable input mechanisms include a variety of control mechanisms including but not limited to a touch or click on a physical input device such as a conventional TV or game console remote, a second-screen device, a foot pedal switch, a sip-and-puff switch, or other adaptive/assistive physical apparatus built to facilitate interaction with electronic devices, as well as alternative input mechanisms such as voice control, sign and gesture control, or eye-tracking control. These physical and non-physical means of interaction may be facilitated by additional onboard or external hardware such as microphones, cameras, accelerometers, spatial sensors (infrared, ultrasonic, etc.) or other specialized peripherals, along with software to assist in processing the relevant signals.

### Second-screen Widget Interface

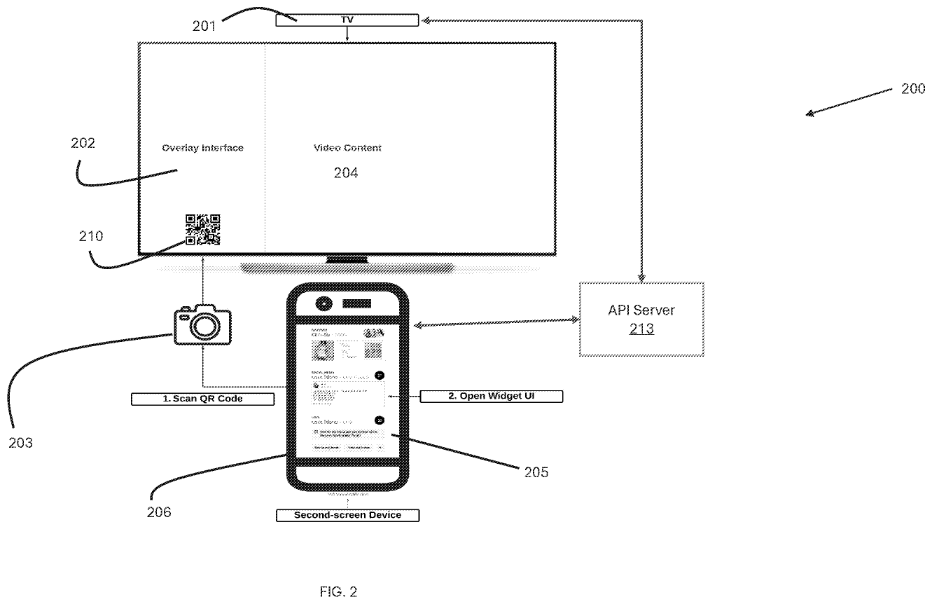

FIG. 2 illustrates a system 200 that displays video content 204 on a primary screen device—here, a television 201—and a widget interface 205 on a second-screen device—here, a smart phone 206 with a camera 203—both of which can communicate with an API server 213. Again, the television 201 can be a smart TV or a television with a separate set-top box. Other suitable primary screen devices (client devices) include computers, tablets, or smart phones. The television 201 may show an overlay notification 202 with a QR code 210 on top of the video content 204. Scanning the QR code 210 with the camera 203 on the smart phone 206 triggers the display of the widget interface 205 on the second-screen device (smart phone 206). The second-screen device 206 can be any device which can display the widget interface 207, receive input signals from the primary device 204 and connect to a network (e.g., the internet). This second-screen device 206 can include, for example, a smart phone, AR/MR/VR headset, tablet, or smart watch.

The specific visual elements of the widget interface 205 displayed on a second-screen device 206 may be adapted to the hardware constraints and screen size of the second-screen device 206. The second-screen experience may involve creating and authenticating into a user profile specific to the widget interface 205. The second-screen experience may be accessed and built in a number of different ways, each of which affects how the primary screen device 201 can be linked to the second-screen device 206. The second-screen device 206 may also use technologies like Bluetooth, WiFi, NFC, or a specialized chip (e.g., an Apple U1 Chip) for connecting or linking to the primary viewing device 204. The ability to access the widget interface 205 on the second-screen device 206 depends on the platform of the primary screen device 201. In the scenario pictured in FIG. 2, the smart phone 206 and television 204 may be associated, paired, or linked with each other via the QR code 202. The smart phone 206 and television 204 can also be linked manually, e.g., by signing into the same user account on both devices or by manually entering a pairing code on the smart phone that is displayed on the television 304 or vice versa.

The smart phone 204 can interpret the QR code 202 photographed by the camera 205 to be a uniform resource locator (URL) with an embedded Device ID (corresponding to the primary viewing device 201) pointing to a web page or mobile application which either directly opens the widget interface 205 or leads to a further authentication step. The further authentication step, if desired, may involve the primary viewing device 201 waiting for the first authentication step (loading the URL endpoint with the specific Device ID) and subsequently displaying a numerical code of arbitrary length which can be entered into the second-screen device 206. The second screen device may require an additional authentication to load user-and service-specific details like preferences, whereas the initial authentication step simply associates the second-screen device with the primary viewing device. The second-screen device 206 may save this authenticated credential locally (e.g., either in a web browser cookie or on a mobile application cache) so that any subsequent scans open the interface directly. Alternatively, the QR code 202 presented on the primary device 201 may include unique parameters that identify the primary device 201 and/or the context of the video content 204 being viewed, such as the timestamp, frame number, and/or other metadata about the video content 204. Scanning this code makes it possible to pair the second-screen device (smart phone 206) and the primary screen device (television 201) without a separate authentication step.

The television 201 and/or the smart phone 206 can communicate with the API server 213 as part of the linking or pairing process. In general, the smart phone 206 can be linked to the television 201 by receiving the context (e.g., timestamp, frame number, metadata, etc.) from the television 201 and using that context to query the API server 213 for appropriate widget metadata. Alternatively, the television 201 can send a device ID to the smart phone 204 and report the context to the API server 213, which sends appropriate widget metadata to the smart phone 204 in response to a request with the device ID from the smart phone 204. By communicating with the API server 213, the smart phone 204 can remain synchronized with the video content 204 on the television 201 even if direct communication between the television 201 and smart phone 204 is not practical or possible. More specifically, the television 201 can report video context to the API server 213, and the smart phone 204 can poll the API server 213 for the latest video context.

A smart phone, tablet, or other second-screen device and an OTT Application primary viewing device (e.g., a Connected TV) may be connected via a user profile if the OTT Application uses one. In this way, the tablet second-screen device may open the widget interface as a web application or mobile application and authenticate using the same credentials as those used for the OTT Application on the primary viewing device.

Other second-screen devices may be connected to primary viewing devices via hardware connections. For example, an external computer monitor second-screen device can be connected to a laptop or desktop computer primary viewing device via a suitable cable (e.g., a HDMI or USB-C cable). If the primary viewing computer device is playing content, the video player may have a button or link which opens a second window on the external computer monitor connected to the primary viewing device. If the two devices are linked in this manner, no additional authentication step is necessary as the second-screen experience is opened from within the original authenticated experience.

Mobile phone second-screen devices and laptop computer primary viewing devices that are Bluetooth-enabled may connect via Bluetooth. The primary viewing device authenticates the second-screen device in the process of connecting to the second-screen device when the second-screen device is within range. Once connected, the primary viewing device can communicate relevant parameters through the Bluetooth connection.

### Interacting With a Widget Interface

The widget interface may be opened automatically at specific points in the video content (e.g., commercial break, audience participation opportunity, big play in a sporting event) or at specific times of day. For instance, the primary screen device may send context to the API server in the background. If the API server determines it is a good time to show the widget interface, then the API server sends a message to the primary screen device or second-screen device that triggers opening of the widget interface. Alternatively, or in addition, the primary screen device or second-screen device may receive from the API server, or may have hard hard-coded, instructions for one or more predetermined contextual events to trigger the interface to open, such as a specific sequence of frames or a particular time of day. When the primary screen device or second-screen device recognizes these one of these events, it opens the widget interface. This may be less flexible than using the API server to trigger opening the widget interface but reduces traffic to the API server. The user may also open the widget interface in response to an overlay or squeeze back notification that appears covering a small portion (e.g., up to 30%) of the screen area, which is interactive. When clicked, this notification opens the full widget interface (e.g., the squeeze back interface in FIG. 1).

Viewers interact with the contextual widget data on the second user interface to engage further with the video data including but not limited to shopping, posting on social media sites, etc. The notification may involve an animation or moving graphic (e.g., a GIF) that demonstrates the utility of the widget interface and may entice the user to open the full widget interface. The notification may also be personalized for each individual user based on data about them (e.g., geography, name, age, gender), learned information about their preferences (e.g., prefers accessories as opposed to clothing), or settings they have chosen.

These widgets can be activated based on temporal location (timestamp) of the video, time data, frame data, user input, or some other event. For example, the user may initiate a query based on video content currently being viewed on a primary user interface, in response to which the API server generates a second user interface (widget interface) including, for example, widgets associated with a product (type, colors, style, prices, etc.), retail providers, etc. Alternatively, the widget interface displaying on a second user interface, may open automatically when the user pauses the content. When the widget interface or a specific widget (application) within the widget interface is opened, a primary or a second-screen device can make a call to an external server which takes various parameters. Parameters may include, but are not limited to, device IDs for the primary screen device and/or second-screen device, user ID, IP address, geographic information, device model (e.g., iphone XR, LG OLED77C3PUA), content ID (e.g. corresponds to TV metadata stored in an external database), timestamp ID (e.g., corresponds to 00:34:12 of a TV show stored in an external database), channel ID (e.g., 12345, corresponds to a channel 2 of a specific cable service provider in a specific geographic region, relevant in the case of a set-top-box-integrated widget interface), local time (e.g., 2023-04-10 00:12:00 UTC), Context Category (e.g., news report, weather report, action sequence).

Based on these parameters and the specific API endpoint called, the API server returns a response (e.g., JSON, protobuf, HTML, iFrame url) which can be used by a primary or a second-screen device to display a contextual experience in the widget interface on a second user interface. The API external server may have access to an external database or databases storing content metadata associated with content IDs, timestamp IDs, context categories and user engagement and preferences associated with device IDs, user IDs, IP addresses, so that at the time that a specific API endpoint is called, these data can be used to inform the API response. Alternatively, this request may be made in advance of the widget interface opening with the results cached for some time so that the widget interface opens with lower latency.

The following example is directed to a scenario in which it is determined that user ID abc123 has a history of interacting with the chat application in the widget interface while watching content ID 12345. For instance, the primary screen device or second-screen device can store data about the user's interactions with the chat application and send it to the API server with a request for a widget. The API server uses the data to choose and sort the widgets it returns in response to the request. Alternatively, the primary screen device or second-screen device can use the locally stored data to sort a complete or unfiltered list of widgets from the API server. Or the primary screen device or second-screen device can report the chat interaction data to the API server as it collects the data (i.e., as the user interacts with the chat application). The API server stores this data and uses it to choose/sort widgets in response to future requests from the primary screen device or the second-screen device for widgets.

A user's history of interacting with a chart widget may cause the widget interface homepage to prioritize the chat application tile when first loaded. If clicked, the chat widget expands to cover the widget interface area and loads data based on the same parameters. Based on the content ID, the chat widget loads a content-specific (e.g., movie or TV show episode) chat room populated with viewers who are also watching or have watched the same piece of video content. Based on timestamp ID, the chat widget filters the chat messages to just those sent by other viewers viewing the same content at the same timestamp or earlier timestamps, replaying chat messages from future timestamp IDs in the chat widgets as the content underneath or beside the chat widget interface progresses.

### Accessing a Widget Interface With Voice Commands

Additionally, in some embodiments, the widget interface may be accessed via voice command recorded by a microphone in a remote control, primary screen device, or second-screen or other device with audio recording capabilities paired with the primary screen device. The audio recording may be transcribed and interpreted on the recording device, the primary device, or an external server to be mapped to a function of the widget interface. For example, the voice command may be sent to an external server, such as the same API server that updates the widget interface or another server called by the API server, that transcribes the audio recording and determines the intent underlying the voice command using a large language model to create a vector representation of the command. The vector representation is derived such that different permutations of commands with the same underlying intent are mapped to similar vectors as determined by a distance or similarity metric and a sufficiently discriminate threshold value to delineate similar and dissimilar intents. Previously determined centroids of intent (i.e., clusters of vectors that have shared intent) are mapped to specific interface behaviors so that at the time of a voice command, the embedding of the voice command will trigger a subsequent call to a behavior corresponding to its closest cluster of intent.

The voice command may be transcribed on the recording device and the transcription may simply be matched for specific words-e.g., “open”, “widget interface”, “shirt”-which match a hard-coded mapping of words to widget interface functions. The end result is a system in which a voice command like “open the widget interface” can in a predetermined manner trigger opening the widget interface home page, whereas “what shirt is she wearing” can trigger opening an application which is focused on product discovery.

The widget interface may also be accessed via platform-dependent touchpoints. For example, in one scenario, a button is displayed in the on-screen interface of the primary screen 204 (e.g., on a home screen, play/pause state modal, channel switch overlay) interacted with, via a pointer device or d-pad (e.g., mouse connected to a computer, remote control paired with a primary device, finger on a touchscreen). The specifics of how specific touchpoints are mapped to specific widget interface behaviors depend on the parent platform of the primary device. For example, connected TVs may have touchpoints built into the TV OS or built into individual OTT applications installed in the TV OS. VR/AR devices may have touchpoints on paired VR/AR remote controllers or through specific physical gestures made and detected by the VR/AR system. Desktop computers may have touchpoints built into the play-bar of a streaming player which appears when pausing while streaming content on a web browser.

### Generating and Selecting Widgets for Display

FIG. 3A illustrates a system for generating, selecting, and displaying a widget interface on a primary viewing device and/or optional second-screen device (collectively, device(s) 307). The system includes a first-party API server 306 in communication with the device(s) 307 and with a metadata database 303, automated content recognition (ACR) server 305, and one or more third-party widget providers 302. Additionally, the one or more third party widget providers 302 can include a server or a content database. In the system of FIG. 3A, widget applications are built using components developed by first-party developers of the core widget interface. The developers of third-party widgets (e.g., third-party widget providers 302) provide manifest files 301 (e.g., in JSON format), each of which contains a list of conditions for when a corresponding widget should be shown based on a predetermined set of contextual parameters. For example, in generating the manifest files 301, parameters such as user location, type of content or more are considered. In creating the manifest file 301, the third-party developer (e.g. third-party widget provider 302) may specify that they want their widget, for example, a sports betting widget, to be shown when the user location is “New York” or “New Jersey” and when the type of content is “NBA Game.”

In operation, the API server 306 receives metadata 311, such as timestamps and/or frame images, about the video content shown on the primary screen device. The API server 306 uses this metadata 311 to query both the ACR server 305 and the metadata database 303 for the contextual parameters and/or conditions laid out in the manifest files 301. The API server 306 uses the manifest files 301, contextual parameters, and/or conditions to determine which widget(s) to display in the widget interface on the device 307 and which widget data 312 to provide to the device 307. The device 307 uses the widget data 312 parsed by the API server 306 from the manifest file(s) 301 to display the associated widget(s) in the widget interface.

When a user is watching a program and the widget interface is loaded, the first-party API server 306 checks the third-party widgets against the current context using their manifest files 301 and determines which widgets have conditions that match the current conditions. This solution is simple but has limited flexibility because the manifest file is static. For example, if a third-party widget developer decides that they do not want their sports-betting widget to show up during Lakers games, they would have to update and re-submit their manifest file.

FIG. 3B illustrates an embodiment in which the third-party developer, server, or database 310 provides an API endpoint that the first-party widget system or server calls to check for applicability of the widget. For example, the applicability check for a sports betting widget may be called with the context of the OTT app user ID in addition to their location and program information. The API endpoint may use the user ID to correlate with the user's sports betting account, recognize that the user has recently lost a substantial amount of money or that the user is located in a region that has not legalized sports betting, and decide not to show the widget in order to promote responsible gambling practices.

FIG. 3B illustrates this dynamic process of providing a widget interface as follows. When the user is watching a program on the primary viewing device 307, the primary viewing device 307 sends frame image metadata and/or timestamp data 311 to the API server 306, which determines which widget interface to load. (The timestamp data 311 can include at least one timestamp or a range of timestamps associated with a timeline of the video content being viewed.) The API server 306 analyzes the video content based on the frame image metadata and/or timestamp data 311 and queries to the ACR server 305 and metadata database 303. Based on the analysis, the API server 306 makes API calls 309 to applicability endpoints registered by the third-party widgets. Once the API server 306 has received these endpoints (widget applicability responses 308) or after some time cut-off to limit slow responses, the API server 306 provides widget data 312 to the viewer via a widget interface display on the device(s) 307.

This method provides flexibility, but it can involve a significant number of third-party API calls. Caching the widget applicability responses 308 at the API server 306 can limit the number of third-party API calls and reduce latency. For example, when a third party registers their API endpoint, or when they respond to a widget request, they may also specify a list of parameters to which changes involve revalidating the applicability of the widget. For example, the sports betting widget may be revalidated for each unique combination of user ID, user location, and program, but not necessarily for each unique timestamp in the program (video content). To simplify this re-validation process, the API server 306 can cache the widget applicability responses 308 on a per-user/per-program basis, so if the same user decides at multiple points in the same program to open the widget interface, then the cached applicability response for that user can be reused. If the applicability responses 308 are stale or the current conditions don't satisfy the criteria laid out in the applicability responses 308, then the API server 306 can make new API calls 309 to the applicability endpoints.

FIG. 3C illustrates an alternative dynamic process for providing widgets. In this process, a third-party developer provides a snippet of code, executable file, or container image 313 to the first-party API server 306, which determines contextual relevance based on the data using the code snippet/container image 313. As in the processes shown in FIGS. 3A and 3B, the API server 306 receives metadata 311 associated with the video content from the primary viewing device and uses that metadata 311 to query the ACR server 305 and metadata database 303 for the contextual conditions/parameters used to determine which widget(s) to show to the viewer. In this case, however, the API server 306 executes the code snippet 313 on the contextual conditions/parameters instead of using a manifest file or API call to determine the widget(s) to populate in the widget interface. This reduces or eliminates communications overhead (bandwidth consumption, etc.) and latency associated with making API calls while providing more dynamic, adaptive analysis than a manifest file. The API server 306 can even cache the resulting outputs to reduce processing time for responding to future widget requests. The API server 306 uses the output generated by the code snippet 313 to determine a list of widgets to be collected and provided to the user in the device 307.

### Powering Dynamic Elements, Payments, or Gamified Elements in Widget Applications

FIGS. 4A and 4B illustrate using a first-party widget controller 415 to power dynamic elements, gamified elements, or payments in widgets in a widget interface 416 on a primary viewing device or second-screen device 407. The first-party widget controller 415 can be implemented as software or firmware executed by a processor of the primary viewing device or second-screen device 407 (whichever displays the widget interface 416 to the viewer). The first-party widget controller 415 communicates with the first-party API server 306 and, optionally, with a first/third-party widget server 414 (FIG. 4A).

FIG. 4A illustrates loading web-based (HTML/CSS/JavaScript) widgets into the widget interface 416 via an iFrame. When the widget interface 416 loads on the device 407, it populates an iFrame for each widget with a URL that may point to a server or database (e.g., first/third-party widget server 314) controlled by the third-party developer that hosts the widget or to a server or database (e.g., first-party API server 306) controlled by the first-party widget interface owner. In the latter case, the code to load in the iFrame is delivered to the widget interface owner (first party) with the submission of the widget for approval, which may reduce flexibility in the third party's ability to update the widget but ensures that changes to the widget can't be made without the first party's approval.

As explained above with respect to FIGS. 3A-3C, the widget controller 415 sends frame image metadata and/or timestamps to the API server 306 and widget data and/or content data, including widget URLs, from the API server 306. The widget controller 415 provides these widget URLs to the widget interface 416, which also requests widget data from the first/third-party widget server 414 and uses this information to provide interactive content via the widgets. At the same time, the widget interface 416 continuously pulls context data from the widget controller 415 and/or the widget controller 415 continuously pushes context data to the widget interface 416.

Communication of context (e.g., current video timestamp) to the widget may be accomplished using the HTML postMessage API, which could then be used to populate the widget interface 416 with the appropriate metadata. In addition, the widget can communicate with a parent widget interface using the HTML postMessage API, for example, to send a signal that the widget should be closed. (The parent widget interface is a first-party service and the child widget service may be either a first-or third-party widget. The parent widget interface hosts the display of first-/third-party widgets on the primary screen/secondary screen viewing device.)

The specification for these signals may be documented and used directly by the widget, or a software development kit (SDK) may be provided which encapsulates these lower-level calls and exposes a simpler set of functions for widget developers to use. In addition to including communication functionality, the SDK may include prebuilt user interface (UI) components (e.g., for JavaScript frameworks like Vue, React, etc.) that are made available to third-party widget developers to use for building their widgets. Some of these components may be optional (e.g., a shopping cart component, an advertisement component, etc.) whereas others (e.g., a close button) may be elements that developers are required to use.

FIG. 4B illustrates building the widget interface 316 using the native components (e.g., native iOS or Android components) of the primary viewing device or second-screen device 307, whichever is showing the widget interface 416, as opposed to components in a web interface. Because there are restrictions on downloading and executing native code on these platforms, the options for building widgets are more limited.

Again, the widget controller 415 provides video content metadata to the first-party API server 306, which responds with widget data and/or context data. In this case, the first-party widget platform (widget controller 415) provides a list of components to use, such as button, image, video, divider, etc., in the widget(s) based on the widget data and, optionally, the context data. Each component may have a list of customizable parameters (e.g., text and a link to load metadata for a subsequent page for the button, a URL to an image for the image, dimensions for all components, etc.). And again, the widget interface 416 continuously pulls context data from the widget controller 415 and/or the widget controller 415 continuously pushes context data to the widget interface 416.

The widget interface 416 may be constructed by making an API call to a server controlled by a third-party developer (e.g., the third-party server 310 in FIG. 3B), which returns an ordered list of components and their metadata with which to build the UI in the widget interface 416. To save on network overhead, this component list may be returned as part of an applicability check via the first-party API server 306 (e.g., as in FIG. 3B) as opposed to through a separate network call.

### Context Identification

The API server can identify context for the video content playing on the primary viewing device and use that context in determining the parameters that are passed into the widget interface. The API server can identify context when the interface is opened, at regular intervals, and/or at discrete times of day. The API server can also be triggered manually by a touchpoint that is made available in the widget interface, thereby updating the context. In addition, this refreshed context may be used to trigger a refresh of the widget interface or specific widgets being used within the widget interface. The API server may cache context information so that when the interface is next opened, the most recent context is available.

The context can take a number of forms at varying levels of granularity. For example, context identification can involve identifying the name of the video content playing, identifying the name of the content and the exact frame that is on display (to within <1 second of accuracy), or can simply involve summarizing the general context or themes of the content without identifying the content or timestamp within the content (e.g., action sequence, news story, comedy set).

The context may be identified in a number of ways. AR/MR/VR primary-screen devices with on-device computing capabilities and chips may be able to identify the context of what is on-screen using a computer vision system that is capable of writing brief summary captions of live audiovisual streams. Such a computer vision system may output a context category (e.g., news report, weather report, action sequence) which may be used to identify relevant widget experiences.

Connected TV devices consuming content may establish context by identifying the exact content ID and timestamp ID. This can be derived by querying an image or series of images, or a representation of the image or series of images from the content and/or an audio clip or a representation of an audio clip from the content against a database pairing content IDs, timestamp IDs, and audiovisual cues. Set-top boxes tuned into specific live, linear, cable television channels may establish context by the exact channel and the current local time. Separately, a process on the back-end server of the core widget interface or of a specific widget application of the interface may keep track of and store on an external database of specific metadata associated with specific channel IDs and specific timestamps, which can be subsequently queried by set-top boxes tuned into these very same channels at the very same time.

### Widget Ecosystem

A widget interface enables users and developers to create and manage personal profiles that can be used to enable a consistent and personalized experience throughout the widget ecosystem. A user profile may be managed via a widget built directly into the widget interface as it appears either on a primary viewing device or a second-screen device. A profile may also be managed on an external app or an external website via a web browser. The user profile may have its metadata (e.g., viewership data, widget engagement data, preferences, ad targeting segments, previously viewed advertisements) stored on an external database, and certain aspects of the data (e.g., User ID) may be shared with third-party widget applications so that these applications can associate metadata with the user. If the widget interface has such a centralized user profile management system, then the unique identifier of an authenticated user may be passed as a parameter into individual widget applications that are opened in addition to contextual metadata.

For example, a user profile may record or store an indication of the frequency of the user's engagement with specific widgets across specific content so that when the user opens the widget interface on either a primary screen device or second-screen device, the widget which the user has engaged with most is ranked or displayed at the top. If the user has interacted most with a “Trivia” widget, then this widget would rank higher than an “Arcade Game” widget when the widget interface is first opened. When the native or API call is made to load the “Trivia” widget, the User ID may be passed as a parameter. If the “Trivia” widget is a first-party application, then the User ID might be used to retrieve past scores, past questions answered, and other engagement data to determine the next trivia game to display. If the widget is a third-party widget, the third-party app developer can store this engagement data alongside this same User ID. In this way, the User ID can be used to associate user metadata across multiple first-party and third-party applications.

The developer profile may be used to enable first-party and third-party developers to create and submit widgets for distribution across devices supporting the widget interface. The profile may store a list of all applications and projects currently under development, pending approval, or released on the platform. Like the user profile, the developer profile may be managed via a widget, an external app, or an external website.

Both the user profile and developer profile may associate information, such as payments information stored in an external database, that can then be retrieved and used for payment functionality throughout the widget ecosystem, including for purchases of goods and services as well as for receiving payments. The widget applications built by developers may conform to specific standards of UI design and user experience (UX), and may involve a submission, review, and approval process before the application is broadly available in the widget interface. The third-party widget applications may have access to the same parameters as the core widget interface to enable contextual and time relevant experiences. Available first-party and third-party widget applications may either be accessible by all viewers across content by default or involve an additional step wherein users select just the widget applications that they would like to interact with to install/enable from a centralized widget store. The centralized widget store may appear as a first-party (native) widget itself which enables searching across all available widgets, installing/enabling individual widgets, and writing/reading reviews of widgets by other users. All widgets will not always be applicable to all content contexts, so an important aspect of a third-party widget ecosystem is ensuring that (only) relevant widgets are shown to users. This can be accomplished in multiple ways as described herein.

### Example Widget Applications

In an exemplary embodiment, a variety of widget applications may be provided in a widget interface. The additional data includes but is not limited to, displaying additional metadata about the content on screen, such as information about characters, products, merchandise, locations, scenes, game and player statistics, or production set, cast, and crew details. The widgets can integrate e-commerce functionality, enabling viewers to view and purchase products related to the content as explained below. They can provide social interaction capabilities, such as chat applications and social media platform integrations. An application may enable viewers to view and interact with social feeds while consuming television content, by linking the user interface displayed on screen to external and third-party social media platforms and may handle authentication into viewers' own social media profiles to enable content creation while viewing. A chat application may synchronize the experience to content being played to prevent spoilers from ruining the experience for those that are consuming and interacting with content at different times.

A widget can offer personalized content recommendations based on the viewer's preferences, viewing history, and past engagement with the interactive UI and enabling opinion-based and fact-based engagement with the content through polls, trivia questions, and quizzes. These polls may be directly or thematically related to the content being consumed, allowing viewers to actively engage with the content on a personal level and see the results of how other viewers have responded. In the case of trivia questions and quizzes, viewers may compete amongst themselves to achieve high scores by answering questions about the cast, crew, production, and other relevant information of the content. This includes providing real-time news and updates relevant to the content or the viewer's interests. These can include live sports scores, stock market updates, or breaking news headlines, allowing viewers to stay informed without interrupting their content consumption.

Widgets can perform other functions, including facilitating language learning through interactive subtitle-based exercises. Additional components which are displayed on a widget interface include but are not limited to are offering accessibility features for individuals with disabilities, including audio descriptions, sign language interpretation, or customizable closed captioning options; enabling co-viewing experiences with friends and family members watching the same content in different locations, including a synchronization feature if the content is being watched at the exact same time; providing access to ratings, reviews, bookmarking, and note-taking capabilities. This application may provide the viewer with insights and additional context about the content they are watching and enable the viewer to share their own insights. A widget interface can integrate weather applications to display local weather information, news, nearby events, and points-of-interest can also be included in a widget interface. It can offer additional media applications to load relevant podcasts and other content related to the content being watched, including press interviews, critical commentary, notable fan-generated content, behind-the-scenes footage, and bonus features. A widget interface can also facilitate targeted advertising of products and services to viewers based on their preferences, viewing history, and the context of the content being watched.

Widgets can enable gaming demos or games related to the intellectual property of content that is currently on display, part of a user's viewership history, or in advance of content rental or purchase. For example, a widget may enable a user to play “Super Mario Bros.” while watching the trailer for “The Super Mario Bros. Movie” or give a user the opportunity to demo the latest Pokemon game while watching the Pokemon TV show. Widgets can provide additional entertainment and gaming widgets that operate independently of the content on display and would effectively allow users to have a multitasking or “dual-screen” experience from within the user interface of a single device.

### Advertising

A widget interface and/or widget applications may provide the ability for brands and advertisers to advertise specific, relevant products and services to viewers based on the viewer's preferences, viewing history, context of content being watched, and viewer engagement, and may further enable engagement with the advertisement including a payment funnel for purchase of a specific product. The interface may display ads like banner ads or sponsored notifications directly on the primary viewing device or on second-screen devices, either in the core widget interface, independently of the widget interface, or within a specific widget application. The advertising infrastructure may be made to be shared across all areas within the interface where advertising is involved to enable a better advertising experience for the viewer. For example, a unified frequency capping system may be employed across all aspects of the advertising infrastructure to ensure the viewer does not see more than a certain number of advertisements within a fixed time period. Targeting may be employed to ensure that the viewer sees (only) relevant advertisements, and these can be informed by viewer engagement across the entire invention and its sub-applications. Revenue from advertising might be shared with developers as a means of encouraging the development of widgets that host ads or drive engagement and shared with users to reward them for engaging with widgets, ads, or media.

### Gamification

In another embodiment, the widget interface may incorporate aspects of gamification of content consumption like points scoring, competition with others, and rules of play as a means of zhuzhing up (e.g., by making more stylish, lively or attractive), engagement within the viewing experience. Examples include but are not limited to, engagement data tracking of the completion of a variety of tasks or challenges such as viewing the entire season of a show, viewing the entire catalog of a director, viewing a certain number of episodes within a certain time of release, spending a certain amount of time watching credit rolls, viewing a variety of genres, viewing content across certain decades, and viewing content containing themes relating to a given holiday, monthly observance, or another current event. Additional examples include social data sharing in the form of leaderboards which allow individuals to compare metadata like viewership stats, rewards, and task/challenge completion with friends and the general public, and data summarization for the purpose of engaging with personal engagement data like hours of viewing activity, most-viewed genres/actors/content types, or soundtrack preferences.

### Transactions and Payments

FIG. 5 discloses a user interface 500 with a primary user interface 501 and a secondary user interface 502, with the second user interface 502 incorporating transactional data for goods and services associated with the content of the primary user interface 501. The second user interface 502 is used for purchasing tickets associated with the sporting event displayed on the primary user interface 501. Additional examples include but not limited to are, behind the scenes footage, items identified on-screen or otherwise related to content (merchandise), and bets placed on sporting or reality TV events. A common SDK/API may be provided to manage transactions platform-wide so that individual first-party or third-party widget developers can rely on a common set of infrastructure, e.g., for storing payment information in a user account, facilitating payments, storing, and displaying user order history, and managing refunds. The payment system may rely on a platform-specific currency native to the widget ecosystem that is used for all transactions by any third-party developers of widgets and additional content, goods, or services.

This may involve facilitating conversion on the platform-not necessarily through the primary viewing device or the second viewing device, but potentially through a web browser signed into a central payments management website-from external currencies to the native currency. This conversion may occur at the time of the transaction itself instead of requiring a separate currency conversion step prior to the transaction. Alternatively, the payment system may rely purely on external currencies, i.e., without a native currency or currency conversion. For example: integrations with payment processing platforms would facilitate payments via credit card, debit card, ACH transfer, wire transfer, cryptocurrency transfer directly.

To ensure a secure and consistent platform-wide payments experience, a shared API/SDK may be used to facilitate aspects of the payment process. This may include UI/UX components involved in the user payment flow (e.g., entering payment information, billing details, currency conversion, cart checkout), which can apply to transactions occurring within third-party widgets, the first-party centralized widget store, or first-party widgets. The API/SDK may allow customization (e.g., UI, payment options, branding), but within limits and potentially subject to review by the first-party. Embodiments of the payment flow include in a first-party or third-party “Product Discovery” widget, which identifies and displays products that are seen in viewed content, a user may be able to add products to a cart within the interface. The widget redirects the user to a centralized payments application built on top of the SDK.

The SDK implements the button which sends a request to an external database to check whether or not the user's account has enough native currency to complete the requested purchase. If a user does not have enough native currency to complete the purchase, the server may respond with an error code that the SDK displays indicating the error. The SDK will render a button alongside a prompt for users to convert external currency to native currency to fund their account. When clicked, this button initiates another common user flow that allows the conversion of external currency to platform-native currency.

This user flow may include integrations with third-party payment processors (ACH, debit, credit) to facilitate conversions. Once the account has been funded with platform-native currency, the user is redirected to the checkout page to complete the order. An additional authorization step may exist according to the payment processor wherein the user will be prompted to confirm their identity or some other authorization code.

An embodiment similar to the prior one, but without the use of a native currency would not require sending a request to an external database to check whether or not the user's account has enough native currency to complete the requested purchase. Instead, the user simply is redirected to the checkout page, and if payment information is not yet entered, the user is directed to fill this information out according to the payment processors integrated and available to the specific widget. Finally, using the payment information, the user can confirm and complete the payment.

In accordance with the invention, the contextual video overlay and squeezeback interface enhances the user experience by providing a wide range of applications and interactive content tailored to the viewer's preferences and the context of the content being consumed. The inventive technology enables viewers to engage with content in a more personalized and contextually relevant manner, resulting in a more immersive and enjoyable viewing experience. Payments may be used to facilitate purchases by users and to facilitate earnings by both developers and users. Developers may have the option of listing widgets on a marketplace as available for free download, or available to download after a fee has been paid through the marketplace. Regardless of whether a widget has a paid or free download, it may have additional monetization mechanisms within the widget's experience such as offering additional features to augment the widget's functionality at an additional fixed or subscription-based cost, running a variety of advertisements within the user experience, offering enhancements for a given experience in a variety of different forms such as downloadable content expansions, power-ups in games, additional “lives” or turns in an interaction loop, trading card packs, loot boxes, access to exclusive events, live in-widget concerts, etc., profiting from the inclusion of sponsored products, giving users an option to donate to creators, earning through affiliate purchase programs, selling user data, amongst other options.

While developers might generally contribute to the ecosystem primarily to profit monetarily, users might be able to earn a variety of rewards that may or may not have any monetary value. For users to directly earn external or platform-native currency through widget engagement, there would be many avenues available such as placing bets through widgets that facilitate gambling using a betting book or even facilitating peer to peer wagers, compensation for sharing their data with applications that monetize it, compensation for viewing, interacting with, and/or sharing an advertisement, compensation for submitting selected content to a widget that supports it (e.g., user-submitted questions to a trivia widget, images to a screensaver widget, or crossword puzzles to a games widget), being paid simply for time spent actively engaging in the ecosystem, compensation for winning ecosystem competitions (e.g., collecting achievements, content viewership, ecosystem engagement rates, etc.) or widget-specific competitions (e.g., trivia, gaming, live sweepstakes, guessing games, etc.). Rewards that would hold no value to others aside from the user earning them would likely be simple achievement-based rewards such as trophies, badges, or other digital audio-visual content that is inextricably linked to an account that cannot be transferred between users. However, the platform could include a system for providing economic incentives for the collection of untradable rewards such as giving users tradable content alongside an untradable badge for completing a task, allowing users to exchange certain trophies for tradable content or currency, rewarding users with currency upon completion of a specified number of achievements, linking rewards within the context of a given widget to rewards in the broader ecosystem through usage of a platform SDK that provides such functionality with certain conditions for participation (e.g., person completes 5 crosswords in a row and receives a badge in the crossword widget as well as a sum of platform currency). Other digital content that users can collect within the ecosystem could be tradable with other users. Exchange between users could rely on a variety of strategies such as simple bartering of items, relying on platform-native currency as an intermediary and standard for commerce, or allowing for transactions to be denominated in external currency.

### Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of designing and making the technology disclosed herein may be implemented using hardware, software or a combination thereof. When implemented in software, the software code can be executed on any suitable processor or collection of processors, whether provided in a single computer or distributed among multiple computers.

The various methods or processes (e.g., of designing and making the technology disclosed above) outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for identifying contextual data for a widget, the method comprising:
receiving, at a first server, a representation of at least one of a frame image or a timestamp of video content displayed to a user via a client device;
determining, based on the representation of the at least one of the frame image or the timestamp using the first server, a third-party widget, based at least in part on the video content;
receiving, by the first server from a second server associated with the third-party widget, information for a widget interface for the third-party widget;
determining, by the first server, widget data based on the information; and
providing, by the first server, the widget data to the widget for display to the user via the widget interface.

2. The method of claim 1, wherein the information comprises a manifest file which includes at least one condition associated with the widget interface.

3. The method of claim 1, wherein the information comprises contextual data including at least the third-party widget associated with the frame image or the timestamp of video content and at least one parameter associated with revalidation of at least the third-party widget.

4. The method of claim 1, wherein the information comprises at least one of a snippet of code, executable file or container image used to determine contextual relevance of at least the third-party widget.

5. The method of claim 1, further comprising:
storing, the information in cache memory in the first server; and
loading the widget interface with at least the third-party widget by populating a container with a URL, the URL pointing to the second server.

6. The method of claim 1, further comprising:
initiating a transaction in the widget interface;
accessing, based on the transaction, a payment platform, wherein the payment platform is accessed by the first server and the second server; and
completing the transaction, based on a response from the payment platform and the contextual data.

7. The method of claim 1, further comprising:
determining, by the first server and based at least in part on at least one contextual parameter, that the widget data is contextually relevant to the video content.

8. The method of claim 7, wherein providing by the first server, the widget data to the widget for display further comprises:
accessing the widget data from cache memory in the first server.

9. The method of claim 7, further comprising:
accessing the widget data from cache memory in the first server in response to a request from a subsequent frame image or timestamp of the video content.

10. The method of claim 1, wherein the first server manages a set of personal profiles, the set of personal profiles including a first profile containing metadata associated with the user including at least one of viewership data, widget engagement data, user preference data, advertisement data, and previously viewed data and a second profile containing a list of applications associated with the widget interface the first profile and the second profile received by the second server and used in determining the information for the widget interface for the third-party widget.

11. The method of claim 1, wherein the third-party widget includes at least one of a product widget, a social media widget or a weather widget, with the product widget displaying products associated with content displayed on the client device, the social media widget allowing the user to interact with posts of at least one social media feed, and the weather widget providing weather information.

12. The method of claim 1, further comprising:
revalidating the third-party widget based on user identification, user location, and programming identification associated with the video content.

13. The method of claim 1, further comprising:
mapping the information for the widget interface to a user identification or programming identification associated with the video content; and
storing the information in cache memory on the first server.

14. The method of claim 1, wherein the widget is web-based and loaded into the widget interface via an inline frame.

15. The method of claim 14, wherein the inline frame is an iFrame component.

16. The method of claim 15, further comprising:
loading the iFrame component with executable code based on the widget information.

17. The method of claim 1, further comprising:
generating the third-party widget based at least in part on a list of components and metadata provided by the second server.

18. The method of claim 17, wherein the information comprises the list of components and the metadata.

19. A method for identifying contextual data, the method comprising:
receiving, at a first server, widget data for a widget interface from a second server or a content database;
caching the widget data at the first server;
validating the widget data for each of a plurality of users and for each of a plurality of types of video content;
receiving, by the first server, an indication that a first user in the plurality of users is viewing a first type of video content in the plurality of types of video content;
attempting to re-validate, by the first server, the widget data for the first user and the first type of video content;
in response to successfully re-validating the widget data, providing the widget data to the first user via a widget interface; and
in response to failure to re-validate the widget data, retrieving, by the first server, new widget data and providing the new widget data to the first user via the widget interface.

20. The method of claim 19, wherein attempting to re-validate the widget data comprises checking a parameter specified by the second server or the content database.

21. The method of claim 19, wherein providing the widget data to the first user comprises:
accessing cached widget data at the first server.

22. The method of claim 19, wherein attempting to re-validate the widget data comprises:
accessing, from the second server, a list of parameters which are associated with the widget data.

23. A method for accessing content in a client device comprising:
displaying, by the client device, video content to a user;
receiving, by the client device, a command relating to the video content from the user;
determining, using a large language model, an intent associated with the command;
generating a vector representation based on the intent;
determining, based at least in part on the vector representation, a widget interface function associated with the video content; and
triggering a display of a widget interface implementing the widget interface function with contextual data associated with the video content, the contextual data determined by a server using a set of predetermined parameters stored on a metadata database.

24. The method of claim 23, wherein the client device includes at least one of a television, a set-top box, a computer, or a mobile device.

25. The method of claim 23, wherein triggering the display of the widget interface causes a second viewing device to display the widget interface.

26. The method of claim 23, wherein triggering the display of the widget interface causes the client device to overlay the widget interface on top of the video content or to display the widget interface as a squeeze back user interface.

27. The method of claim 23, wherein the widget interface further displays at least one of a product widget providing information associated with at least one product displayed on the primary user interface, a social media widget allowing the user to interact with at least one social media feed, and a weather widget.

28. The method of claim 23, wherein the vector representation is associated with a plurality of commands corresponding to the intent, and a plurality of additional vector representations are mapped to the plurality of commands and the intent.

29. The method of claim 23, wherein determining the intent further comprises:
mapping at least one cluster of vector representations to the intent.

30. The method of claim 29, wherein mapping at least one cluster of vector representations further comprises:
mapping user interface data to the at least one cluster of vector representations associated with the intent.
